(19) United States
(12) Patent Application Publication
(10) Pub. No.: US 2025/0279450 A1
(43) Pub. Date: Sep. 4, 2025

(54) FUEL CELL SYSTEM

(71) Applicant: TOYOTA JIDOSHA KABUSHIKI KAISHA, Toyota-shi (JP)

(72) Inventors: Atsuo IIO, Nagoya-shi (JP); Keisuke YOKOTA, Nisshin-shi (JP); Kazuo YAMAMOTO, Toyota-shi (JP); Morio SHINODA, Anjo-shi (JP)

(73) Assignee: TOYOTA JIDOSHA KABUSHIKI KAISHA, Toyota-shi (JP)

(21) Appl. No.: 19/037,462

(22) Filed: Jan. 27, 2025

(30) Foreign Application Priority Data
Mar. 1, 2024 (JP) 2024-031216

(51) Int. Cl. H01M 8/04746; H01M 8/04082; H01M 8/04225; H01M 8/04302; H01M 8/0438

(52) U.S. Cl. CPC H01M 8/04753; H01M 8/04201; H01M 8/04225; H01M 8/04302; H01M 8/04388

(57) ABSTRACT

The fuel cell system includes a fuel cell, a fuel gas tank, a gas flow path, a pressure reducing valve, a pressure sensor for acquiring the pressure of the gas on the side of the fuel cell with respect to the pressure reducing valve, an operation storage unit for storing the length of the deactivation period of the fuel cell system, and a control unit. The control unit performs start control for starting the operation of the fuel cell when the first start condition including that the pressure acquired by the pressure sensor is smaller than the first pressure threshold is satisfied, and performs start control when the second start condition including that the pressure acquired by the pressure sensor is larger than the first pressure threshold and the length of the pause period stored in the operation storage unit is larger than the pause threshold is satisfied.

### CROSS-REFERENCE TO RELATED APPLICATION

This application claims priority to Japanese Patent Application No. 2024-031216 filed on Mar. 1, 2024, incorporated herein by reference in its entirety.

### BACKGROUND

### 1. Technical Field

The present disclosure relates to a fuel cell system.

### 2. Description of Related Art

Conventionally, there is a fuel cell system including a hydrogen tank, a shut-off valve, a pressure reducing valve, and a pressure regulating valve in a path to supply hydrogen to a fuel cell stack. The high-pressure hydrogen gas supplied from the hydrogen tank passes through the pressure reducing valve and the pressure regulating valve, is adjusted to an appropriate pressure and amount, and is supplied to the fuel cell stack. When the fuel cell system is not in operation, the pressure reducing valve and the pressure regulating valve are closed. There is a technique in which an abnormality is determined in such a fuel cell system when the pressure in the flow path between the pressure reducing valve and the pressure regulating valve is more than a threshold when an instruction to start operation is provided.

### SUMMARY

When the fuel cell system is not operated for a long period, the pressure in the flow path between the pressure reducing valve and the pressure regulating valve may become more than the threshold because of the hydrogen gas that has passed through a seal portion of the pressure reducing valve during the period. In such a case, an abnormality is determined and the operation of the fuel cell system is restricted, even when there is no abnormality in the pressure reducing valve provided in the path to supply hydrogen.

The present disclosure can be implemented in the following aspects.

(1) An aspect of the present disclosure provides a fuel cell system. This fuel cell system includes:
a fuel cell;
a fuel gas tank that holds a fuel gas;
a gas flow path that connects the fuel cell and the fuel gas tank to allow the fuel gas to flow through the gas flow path;
a pressure reducing valve provided in the gas flow path, capable of allowing the fuel gas supplied from the fuel gas tank to flow through the pressure reducing valve with a pressure of the fuel gas reduced, and capable of shutting off the fuel gas supplied from the fuel gas tank;
a pressure sensor capable of acquiring a pressure in the gas flow path on a side of the fuel cell with respect to the pressure reducing valve;
an operation storage unit that stores a length of a quiescent period of the fuel cell system; and
a control unit that controls the fuel cell system.
The control unit performs start control for starting operation of the fuel cell when an instruction to start the operation of the fuel cell is received, and
when a first start condition is met, the first start condition including the pressure acquired by the pressure sensor being less than a first pressure threshold determined in advance; and the control unit performs the start control when a second start condition is met, the second start condition including the pressure acquired by the pressure sensor being more than the first pressure threshold and the length of the quiescent period stored in the operation storage unit being more than a quiescent threshold determined in advance.
According to this aspect, it is possible to avoid a situation in which the start control is not performed when the pressure in the gas flow path on the fuel cell side with respect to the pressure reducing valve becomes more than the first pressure threshold since the quiescent period in which the operation of the fuel cell is not performed is more than the quiescent threshold, even if there is no abnormality in the function of the pressure reducing valve. That is, the start control for starting the operation of the fuel cell can be performed as when the pressure in the gas flow path on the fuel cell side with respect to the pressure reducing valve is less than the first pressure threshold.
(2) The fuel cell system according to the above aspect may further include
an adjusting unit provided in the gas flow path on a side of the fuel cell with respect to the pressure reducing valve to receive the fuel gas and supply the fuel gas to the fuel cell at a specified opening degree, and
a power supply storage unit that stores a shutoff of supply of power to the operation storage unit;
the pressure sensor may acquire a pressure in the gas flow path between the pressure reducing valve and the adjusting unit; and the control unit may perform the start control when an instruction to start the operation of the fuel cell is received and when a third start condition is met, the third start condition including
(i) the pressure acquired by the pressure sensor being more than the first pressure threshold,
(ii) a shutoff of supply of power to the operation storage unit being stored, and
(iii) the pressure acquired by the pressure sensor becoming less than a second pressure threshold determined in advance after the adjusting unit is caused to supply the fuel gas toward the fuel cell.
According to this aspect, it is possible to avoid a situation in which the start control is not performed, even if there is no abnormality in the function of the pressure reducing valve, when the pressure in the gas flow path on the fuel cell side with respect to the pressure reducing valve becomes more than the first pressure threshold since the length of the quiescent period in which the operation of the fuel cell is not performed is more than the quiescent threshold, and when the length of the quiescent period is not stored in the operation storage unit since the supply of power to the operation storage unit is shut off. In that event, it is possible to avoid a situation in which the start control is performed even if there is an abnormality in the function of the pressure reducing valve, since the start control is performed on condition that the pressure acquired by the pressure sensor becomes less than the second pressure threshold after the adjusting unit is caused to supply the fuel gas toward the fuel cell.
(3) The fuel cell system according to the above aspect may further include
a main stop valve provided in the gas flow path on a side of the fuel gas tank with respect to the pressure reducing valve to allow or shut off a flow of the fuel gas; and
the pressure acquired by the pressure sensor becoming less than the second pressure threshold after the adjusting unit is caused to supply the fuel gas toward the fuel cell may include the pressure acquired by the pressure sensor becoming less than the second pressure threshold within a time threshold determined in advance after the adjusting unit is caused to supply the fuel gas toward the fuel cell with the main stop valve in a closed state.
According to this aspect, a reduction in the pressure on the downstream side of the pressure reducing valve is checked with the main stop valve in the closed state. Therefore, it is possible to reduce the possibility that the fuel gas is ejected to the outside with the adjusting unit exposed to the high-pressure fuel gas to be broken, or with a relief mechanism provided in the adjusting unit opened, when the pressure reducing valve has failed.
(4) Another aspect of the present disclosure provides a fuel cell system.
This fuel cell system includes:
a fuel cell;
a fuel gas tank that holds a fuel gas;
a gas flow path that connects the fuel cell and the fuel gas tank to allow the fuel gas to flow through the gas flow path;
a pressure reducing valve provided in the gas flow path, capable of allowing the fuel gas supplied from the fuel gas tank to flow through the pressure reducing valve with a pressure of the fuel gas reduced, and capable of shutting off the fuel gas supplied from the fuel gas tank;
an adjusting unit provided in the gas flow path on a side of the fuel cell with respect to the pressure reducing valve to receive the fuel gas and supply the fuel gas to the fuel cell at a specified opening degree;
a pressure sensor capable of acquiring a pressure in the gas flow path between the pressure reducing valve and the adjusting unit; and a control unit that controls the fuel cell system. The control unit performs start control for starting operation of the fuel cell when an instruction to start the operation of the fuel cell is received, and
when a start condition is met, the start condition including the pressure acquired by the pressure sensor being less than a first pressure threshold determined in advance; and
the control unit performs the start control when an additional start condition is met, the additional start condition including
(i) the pressure acquired by the pressure sensor being more than the first pressure threshold, and
(ii) the pressure acquired by the pressure sensor becoming less than a second pressure threshold determined in advance after the adjusting unit is caused to supply the fuel gas toward the fuel cell.
According to this aspect, it is possible to avoid a situation in which the start control is not performed, even if there is no abnormality in the function of the pressure reducing valve, when the pressure in the gas flow path on the fuel cell side with respect to the pressure reducing valve becomes more than the first pressure threshold since the quiescent period in which the operation of the fuel cell is not performed is long. In that event, it is possible to avoid a situation in which the start control is performed even if there is an abnormality in the function of the pressure reducing valve, since the start control is performed on condition that the pressure acquired by the pressure sensor becomes less than the second pressure threshold after the adjusting unit is caused to supply the fuel gas toward the fuel cell.
The present disclosure can be implemented in various forms other than the fuel cell system. For example, the present disclosure can be implemented in the form of a method of manufacturing a fuel cell system, a method of controlling a fuel cell system, a computer program that implements the control method, a non-transitory storage medium storing the computer program, etc.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a schematic configuration of a fuel cell system 100 according to the present embodiment;

FIG. 2 is a flow chart showing a process executed when an instruction Is indicating that the operation of the fuel cell 20 should be started is received;

FIG. 3 is a flow chart showing a process in the second embodiment executed when an instruction Is indicating that the operation of the fuel cell 20 should be started is received;

FIG. 4 is a flow chart showing a process in the third embodiment executed when an instruction Is indicating that the operation of the fuel cell 20 should be started is received; and

FIG. 5 is a flow chart showing a process of the third embodiment executed when an instruction Is indicating that the operation of the fuel cell 20 should be started is received.

### DETAILED DESCRIPTION OF EMBODIMENTS

### A. First Embodiment

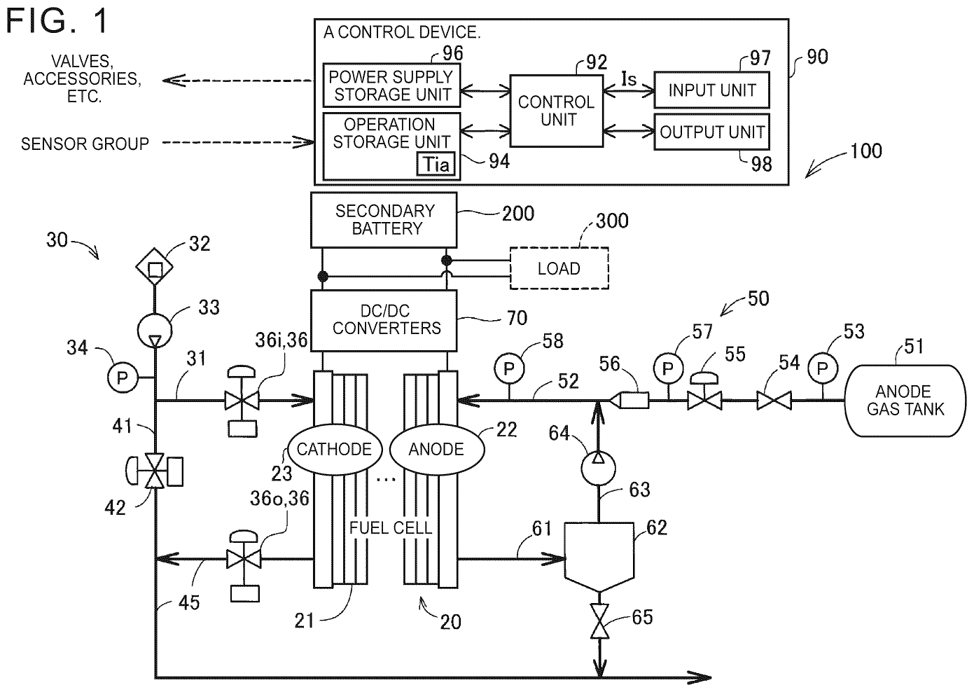

FIG. 1 is a schematic diagram illustrating a schematic configuration of a fuel cell system 100 according to the present embodiment. The fuel cell system 100 is mounted on a vehicle. The fuel cell system 100 supplies electric power to a load 300 mounted on the vehicle.

The vehicle includes a fuel cell system 100, a secondary battery 200, and a load 300. The load 300 functions by being supplied with electric power from the fuel cell system 100 and the secondary battery 200. The load 300 includes a drive motor for moving the vehicle, an air conditioning facility for adjusting a temperature in the vehicle cabin, and the like.

The fuel cell system 100 includes a fuel cell 20, a cathode gas supply/discharge system 30, an anode gas supply/discharge system 50, a DC/DC converter 70, and a control device 90.

In the fuel cell 20, air as a cathode gas is supplied from the cathode gas supply/discharge system 30, and hydrogen gas as an anode gas is supplied from the anode gas supply/discharge system 50 to generate electric power (see the lower center portion in FIG. 1). The fuel cell 20 is a polymer electrolyte fuel cell. The fuel cell 20 has a stack structure including a plurality of stacked single cells 21. The single cell 21 includes an anode 22 and a cathode 23. The single cell 21 generates electric power by supplying hydrogen gas to the anode 22 and air to the cathode 23. The single cell 21 constitutes the smallest unit of power generation. In FIG. 1, the anode 22 and the cathode 23 of each unit cell 21 are collectively shown for ease of understanding of the technology.

The cathode gas supply/discharge system 30 supplies the cathode gas to the fuel cell 20, and discharges the cathode off-gas discharged from the fuel cell 20 to the outside of the fuel cell system 100 (see the left part of the middle stage in FIG. 1). The cathode gas supply/discharge system 30 includes a cathode gas supply flow path 31, an air flow meter 32, a compressor 33, a cathode pressure sensor 34, a flow regulating valve 36, a bypass flow path 41, a flow dividing valve 42, and a cathode off-gas discharge flow path 45.

The cathode gas supply flow path 31 is a flow path for supplying the air taken in from the outside of the fuel cell system 100 to the fuel cell 20 as the cathode gas (see the left part of the middle stage in FIG. 1). In the cathode gas supply flow path 31, an air flow meter 32, a compressor 33, a cathode pressure sensor 34, and a flow regulating valve 36i are provided in that order.

The air flow meter 32 detects the flow rate of the cathode gas taken into the cathode gas supply flow path 31. The compressor 33 compresses the cathode gas supplied by the cathode gas supply flow path 31 and supplies the compressed cathode gas to the downstream side. The cathode pressure sensor 34 detects the pressure in the cathode gas supply flow path 31 on the fuel cell 20 side with respect to the compressor 33. The flow regulating valve 36i regulates the flow rate of the cathode gas flowing through the cathode gas supply flow path 31.

The cathode off-gas discharge flow path 45 is a flow path for discharging the cathode off-gas discharged from the fuel cell 20 to the outside of the fuel cell system 100 (see the lower left portion in FIG. 1). A flow regulating valve 360 is provided in the cathode off-gas discharge flow path 45. The flow regulating valve 360 regulates the flow rate of the cathode off-gas flowing through the cathode off-gas discharge flow path 45. In this specification, the flow regulating valve 36i and the flow regulating valve 360 are collectively referred to as a “flow regulating valve 36”.

The bypass flow path 41 is a flow path connecting the cathode gas supply flow path 31 and the cathode off-gas discharge flow path 45 (see the left part of the middle stage in FIG. 1). A flow dividing valve 42 is provided in the bypass flow path 41. The flow dividing valve 42 can adjust the flow rate of the cathode gas flowing through the bypass flow path 41, and can further block the flow of the cathode gas in the bypass flow path 41. The flow of the cathode gas supplied from the cathode gas supply flow path 31 is divided into a flow toward the fuel cell 20 and a flow toward the bypass flow path 41 by the flow dividing valve 42.

The anode gas supply/discharge system 50 supplies the anode gas to the fuel cell 20, and discharges the anode off-gas discharged from the fuel cell 20 to the outside of the fuel cell system 100 (see the lower right part in FIG. 1). The anode gas supply/discharge system 50 includes an anode gas tank 51, an anode gas supply passage 52, a main stop valve 54, a pressure reducing valve 55, an adjusting unit 56, and pressure sensors 53, 57, and 58. The anode gas supply/discharge system 50 further includes an anode gas discharge path 61, a gas-liquid separator 62, a circulation flow path 63, an anode gas pump 64, and an exhaust drain valve 65.

The anode gas tank 51 holds the anode gas (see the right part of the middle stage in FIG. 1). More specifically, the anode gas tank 51 stores hydrogen gas having a pressure higher than that of the hydrogen gas supplied to the fuel cell 20.

The anode gas supply passage 52 is a flow passage that connects the fuel cell 20 and the anode gas tank 51 and allows the anode gas to flow therethrough (see the right portion of the middle stage in FIG. 1). In the anode gas supply passage 52, a pressure sensor 53, a main stop valve 54, a pressure reducing valve 55, a pressure sensor 57, an adjusting unit 56, and a pressure sensor 58 are provided in that order.

The main stop valve 54 is provided in the anode gas supply passage 52 at a position on the side of the anode gas tank 51 with respect to the pressure reducing valve 55. The main stop valve 54 allows or blocks the flow of the anode gas.

The pressure reducing valve 55 can lower and flow the pressure of the anode gas supplied from the anode gas tank 51, and can shut off the anode gas supplied from the anode gas tank 51.

The adjusting unit 56 is provided in the anode gas supply passage 52 on the side of the fuel cell 20 with respect to the pressure reducing valve 55. The adjusting unit 56 may take various degrees of opening. The larger the opening degree, the larger the flow rate of the anode gas flowing downstream from the adjusting unit 56. The adjusting unit 56 receives the anode gas and supplies the anode gas to the fuel cell 20 at a specified opening degree. Specifically, the adjusting unit 56 is a linear solenoid valve.

The pressure sensors 53, 57, and 58 acquire the pressure in the anode gas supply passage 52. The pressure sensor 53 acquires the pressure of the anode gas supplied from the anode gas tank 51. Specifically, the pressure sensor 53 acquires the pressure in the anode gas supply passage 52 on the side of the anode gas tank 51 with respect to the main stop valve 54. The pressure sensor 57 can acquire the pressure in the anode gas supply passage 52 on the side of the fuel cell 20 with respect to the pressure reducing valve 55. More specifically, the pressure sensor 57 acquires the pressure in the anode gas supply passage 52 between the pressure reducing valve 55 and the adjusting unit 56. The pressure sensor 58 acquires the pressure in the anode gas supply passage 52 on the fuel cell 20 side with respect to the connection portion with the circulation flow path 63.

The anode gas discharge path 61 is a flow path that connects the fuel cell 20 and the gas-liquid separator 62 and supplies the anode off-gas discharged from the fuel cell 20 to the gas-liquid separator 62 (see the lower center portion in FIG. 1). The anode off-gas discharged from the fuel cell 20 includes an anode gas, liquid water, and an impurity gas that are not used in the electrochemical reaction in the fuel cell 20.

The gas-liquid separator 62 separates the liquid water from the anode off-gas containing the liquid water (see the lower middle portion in FIG. 1). An exhaust drain valve 65 is connected to the gas-liquid separator 62.

The exhaust drain valve 65 allows or blocks the discharge of liquid water and impurity gases from the gas-liquid separator 62. The exhaust drain valve 65 is normally closed and opens in response to a command from the control device 90. As a result, the liquid water and the impurity gas separated from the anode off-gas by the gas-liquid separator 62 are discharged to the outside of the fuel cell system 100 via the cathode off-gas discharge flow path 45.

The circulation flow path 63 connects the portion of the anode gas supply passage 52 on the fuel cell 20 side to the adjusting unit 56 and the gas-liquid separator 62 (see the middle portion of FIG. 1). The circulation flow path 63 is a flow path for supplying the anode off-gas from which the liquid water and the impurity gas are removed, which is supplied from the gas-liquid separator 62, to the anode gas supply passage 52. An anode gas pump 64 is provided in the circulation flow path 63.

The anode gas pump 64 supplies the anode off-gas supplied from the gas-liquid separator 62 to the anode gas supply passage 52. As a result, the anode off-gas supplied through the gas-liquid separator 62 and the anode gas supplied from the anode gas tank 51 are supplied to the fuel cell 20 through the anode gas supply passage 52.

DC/DC converters 70 are disposed between electrically connected loads 300 and the fuel cell 20 (see the middle section of FIG. 1). DC/DC converters 70 receive power from the fuel cell 20 and convert the voltage to a desired voltage. The power outputted by DC/DC converters 70 is supplied to the loads 300 via inverters.

In FIG. 1, a fuel cell system 100 and a load 300 are shown as separate configurations for ease of understanding of the technology. However, the load 300 includes auxiliary equipment such as the compressor 33 and the anode gas pump 64 of the fuel cell system 100 in addition to the drive motor and the air conditioning equipment of the vehicle.

The control device 90 controls the fuel cell system 100 (see the upper part of FIG. 1). The control device 90 is a so-called ECU (Electronic Control Unit). The control device 90 includes a control unit 92 that is a CPU (Central Processing Unit), an operation storage unit 94, a power supply storage unit 96, an input unit 97, and an output unit 98.

The control unit 92 controls the fuel cell system 100. Specifically, the control unit 92 controls the fuel cell system 100 by executing a program stored in the operation storage unit 94. In addition to the sensors included in the fuel cell system 100 such as the cathode pressure sensor 34, the pressure sensor 53, and the pressure sensor 57, a detection signal is input to the control unit 92 from a sensor group such as an accelerator operation amount sensor or a vehicle speed sensor of the vehicle. The control unit 92 controls each unit by outputting a drive signal to each unit related to power generation of the fuel cell 20, including the main stop valve 54, the pressure reducing valve 55, the adjusting unit 56, the anode gas pump 64, and the exhaust drain valve 65. For example, the control unit 92 instructs the adjusting unit 56 to indicate the opening degree.

The control unit 92 records the length Tia of the deactivation period of the fuel cell system 100 in the operation storage unit 94. The rest period is a period in which the anode gas and the cathode gas are not supplied to the fuel cell 20 and power generation is not performed in the fuel cell 20. Specifically, the control unit 92 records, in the operation storage unit 94, the length of the period from the input of the instruction to end the operation of the fuel cell system 100 via the input unit 97 to the input of the instruction to start the operation of the fuel cell system 100 via the input unit 97 as the length Tia of the pause period. That is, when an instruction to end the operation of the fuel cell system 100 is input, the control unit 92 records the time at that time in the operation storage unit 94, stops the supply of the anode gas and the cathode gas to the fuel cell 20, and stops the power generation by the fuel cell 20. After that, when an instruction to start the operation of the fuel cell system 100 is first input, the control unit 92 records the time at that time in the operation storage unit 94, resumes the supply of the anode gas and the cathode gas to the fuel cell 20, and resumes the power generation by the fuel cell 20. Then, the control unit 92 records, in the operation storage unit 94, the length of the period from the time at which the instruction to end the operation of the fuel cell system 100 is input to the time at which the instruction to start the operation of the fuel cell system 100 is input first, as the length Tia of the pause period.

The control unit 92 records the interruption of the supply of electric power to the operation storage unit 94 in the power supply storage unit 96. The interruption of the supply of electric power to the operation storage unit 94 occurs, for example, when the secondary battery 200 is removed from the vehicle and replaced. The function of the control unit 92 may be realized by software or by a hardware circuit.

The operation storage unit 94 stores a program for controlling the fuel cell system 100 and data used for controlling the fuel cell system 100. The operation storage unit 94 stores, for example, the length Tia of the last pause period among the pause periods of the fuel cell system 100. Specifically, the operation storage unit 94 includes RAM (Random Access Memory) and ROM (Read Only Memory). The length Tia of the deactivation period of the fuel cell system 100 is stored in RAM.

The power supply storage unit 96 stores a program for controlling the fuel cell system 100 and data used for controlling the fuel cell system 100. The power supply storage unit 96 stores, for example, interruption of power supply to the operation storage unit 94. Specifically, the power supply storage unit 96 includes a rewritable nonvolatile memory. Therefore, the history of interruption of the supply of power to the operation storage unit 94 stored in the power supply storage unit 96 is not lost even if the supply of power to the fuel cell system 100 is interrupted.

The input unit 97 receives an instruction related to the operation of the fuel cell system 100 from the driver of the vehicle, and inputs the instruction to the control unit 92. Specifically, the input unit 97 is a switch for receiving an instruction to start or end the operation of the fuel cell 20, or a touch panel for instructing an operation mode of the fuel cell 20.

The output unit 98 is controlled by the control unit 92 and outputs information related to the operation of the fuel cell system 100 to the driver of the vehicle. Specifically, the output unit 98 is a liquid crystal display.

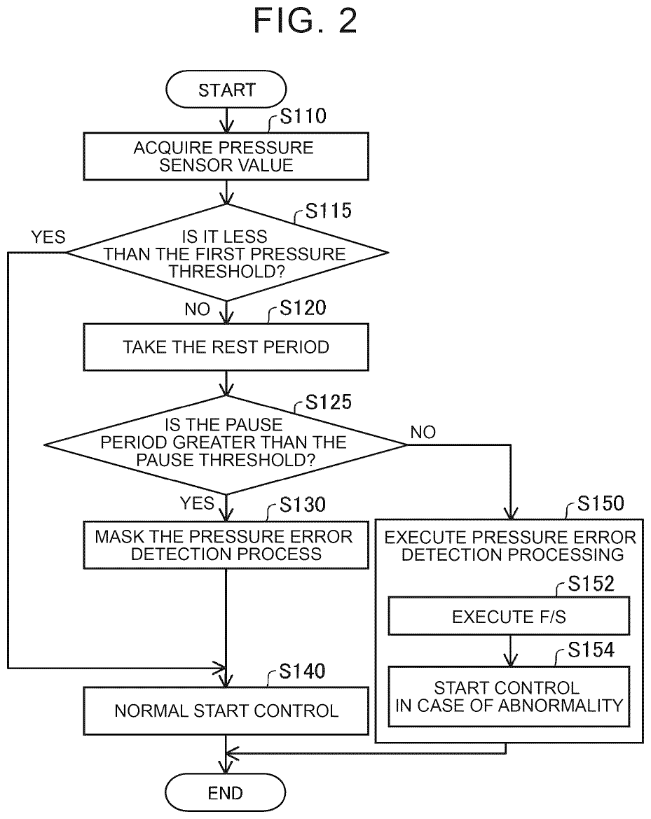

FIG. 2 is a flow chart showing a process executed when an instruction Is indicating that the operation of the fuel cell 20 should be started is received (see the upper part of FIG. 1). The processing illustrated in FIG. 2 is executed by the control unit 92.

In step 110, the control unit 92 acquires the pressure in the anode gas supply passage 52 between the pressure reducing valve 55 and the adjusting unit 56 from the pressure sensor 57 (see the right part of the middle stage in FIG. 1). At this time, the main stop valve 54 and the pressure reducing valve 55 are closed.

In step 115, the control unit 92 determines whether the pressure Pm acquired by the pressure sensor 57 is smaller than a predetermined first pressure threshold Pth1. If the pressure Pm is less than the first pressure threshold Pth1, the process proceeds to step 140. If the pressure Pm is greater than or equal to the first pressure threshold Pth1, the process proceeds to step 120.

In step 120, the control unit 92 acquires the length Tia of the pause period stored in the operation storage unit 94 (see the upper part of FIG. 1).

In step 125, the control unit 92 determines whether or not the length Tia of the pause period stored in the operation storage unit 94 is greater than a predetermined pause threshold Tthia. If the length Tia of the pause period is greater than the pause threshold Tthia, the process proceeds to step 130. If the length Tia of the pause period is less than or equal to the pause threshold Tthia, the process proceeds to step 150.

In step 130, the pressure abnormality detection process is masked. That is, the process of step 150 is not executed, and the process proceeds to step 140.

In step 140, the control unit 92 starts the normal start control. Specifically, valves such as the main stop valve 54 and the pressure reducing valve 55 are opened, and start control for starting the operation of the fuel cell 20 is performed (see the right part of the middle stage in FIG. 1).

In the process of FIG. 2, the process of step 140 is performed when Yes determination is performed in step 115 and when Yes determination is performed in step 125. The case where Yes determination is performed in step 115 is a case where the first starting condition that the pressure Pm acquired by the pressure sensor 57 is smaller than the predetermined first pressure threshold Pth1 is satisfied.

In step 150, the control unit 92 executes a pressure abnormality detection process. Step 150 includes step 152,154. In step 152, the control unit 92 performs fail-safe processing. Specifically, the control unit 92 performs setting so that, even if an instruction Is indicating that the operation of the fuel cell 20 should be started is input via the input unit 97, the power is turned off immediately after the power is turned on. This setting is stored in the non-volatile memory. In step 154, the control unit 92 performs start control at the time of abnormality. Specifically, the control unit 92 closes the main stop valve 54 and stops the fuel cell system 100.

For example, when the pressure reducing valve 55 cannot sufficiently shut off the anode gas due to the deterioration of the seal portion, the anode gas in the anode gas supply passage 52 between the pressure reducing valve 55 and the main stop valve 54 enters the anode gas supply passage 52 between the pressure reducing valve 55 and the adjusting unit 56 through the pressure reducing valve 55 during the deactivation period of the fuel cell system 100. Consequently, even in a short period in which the length Tia of the pause period is equal to or less than the pause threshold Tthia, the pressure in the anode gas supply passage 52 between the pressure reducing valve 55 and the adjusting unit 56 becomes equal to or greater than the pause threshold Tthia (see S115: No and S125: No in FIG. 2). In the present embodiment, in such a case, the pressure abnormality detection process in step 150 is performed. Therefore, when there is an abnormality in the function of the pressure reducing valve 55, it is possible to avoid the operation of the fuel cell system 100 contrary to the instruction from the driver.

On the other hand, even when the pressure reducing valve 55 is capable of sufficiently shutting off the anode gas, the anode gas in the anode gas supply passage 52 between the pressure reducing valve 55 and the main stop valve 54 leaks slightly from the pressure reducing valve 55 and enters the anode gas supply passage 52 between the pressure reducing valve 55 and the adjusting unit 56. Therefore, when the deactivation period of the fuel cell system 100 is long, the pressure in the anode gas supply passage 52 between the pressure reducing valve 55 and the adjusting unit 56 may be equal to or higher than the deactivation threshold Tthia. Such a condition may occur, for example, when the owner of the vehicle replaces the pressure reducing valve 55 after the purchase of the vehicle.

In the present embodiment, when the first start condition including that the pressure Pm acquired by the pressure sensor 57 is smaller than the predetermined first pressure threshold Pth1 is satisfied, start control for starting the operation of the fuel cell 20 is performed (see S115: Yes and S140 in FIG. 2). Further, the start control is also performed when the second start condition including that the pressure Pm acquired by the pressure sensor 57 is larger than the first pressure threshold Pth1 and the length Tia of the pause period stored in the operation storage unit 94 is larger than the predetermined pause threshold Tthia is satisfied (see S115: No, S125: Yes and S140 in FIG. 2).

Therefore, in the present embodiment, since the pause period in which the operation of the fuel cell 20 is not performed is larger than the pause threshold Tthia even though the function of the pressure reducing valve 55 is not abnormal, it is possible to avoid a situation in which the starting control is not performed when the pressure in the anode gas supply passage 52 on the fuel cell 20 side becomes larger than the first pressure threshold Pth1 with respect to the pressure reducing valve 55. That is, the starting control for starting the operation of the fuel cell 20 can be performed in the same manner as when the pressure in the anode gas supply passage 52 on the fuel cell 20 side is smaller than the first pressure threshold Pth1 with respect to the pressure reducing valve 55.

The anode gas in the present embodiment is also referred to as “fuel gas”. The anode gas tank 51 is also called a “fuel gas tank”. The anode gas supply passage 52 is also referred to as a “gas flow path”.

### B. Second Embodiment

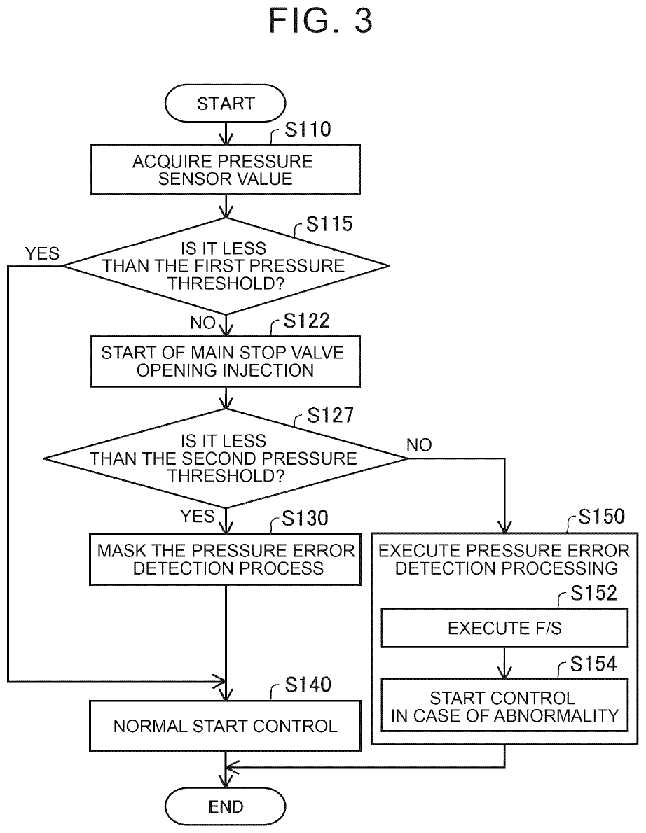

FIG. 3 is a flow chart showing a process in the second embodiment executed when an instruction Is indicating that the operation of the fuel cell 20 should be started is received (see the upper part of FIG. 1). In the process of FIG. 3, the process of step 122,127 is executed instead of the process of step 120,125 of FIG. 2. The configuration and processing of the fuel cell system of the second embodiment are the same as those of the fuel cell system 100 of the first embodiment. In FIG. 3, the steps that perform the same processing as the steps illustrated in FIG. 2 are denoted by the same reference numerals.

In step 122, the control unit 92 opens the main stop valve 54 and causes the adjusting unit 56 to supply the anode gas. At this time, the pressure reducing valve 55 is closed.

After a predetermined time elapses after the fuel gas is supplied to the adjusting unit 56, the control unit 92 acquires the pressure in the anode gas supply passage 52 between the pressure reducing valve 55 and the adjusting unit 56 from the pressure sensor 57 (see the right part of the middle stage in FIG. 1).

In step 127, the control unit 92 determines whether the pressure Pm acquired by the pressure sensor 57 is smaller than a predetermined second pressure threshold Pth2.

In the anode gas supply passage 52, when the pressure reducing valve 55 is capable of sufficiently shutting off the anode gas, when the fuel gas is supplied to the adjusting unit 56, the anode gas in the anode gas supply passage 52 between the pressure reducing valve 55 and the adjusting unit 56 flows downstream. Therefore, the pressure in the anode gas supply passage 52 between the pressure reducing valve 55 and the adjusting unit 56 is greatly reduced. If so, a Yes determination is made at step 127.

On the other hand, in the anode gas supply passage 52, when the pressure reducing valve 55 cannot sufficiently shut off the anode gas, the anode gas between the pressure reducing valve 55 and the adjusting unit 56 flows downstream, while the anode gas of the anode gas tank 51 enters the anode gas supply passage 52 between the pressure reducing valve 55 and the adjusting unit 56 via the main stop valve 54 and the pressure reducing valve 55. Therefore, even if the fuel gas is supplied to the adjusting unit 56, the pressure in the anode gas supply passage 52 between the pressure reducing valve 55 and the adjusting unit 56 does not decrease. If so, a No determination is made at step 127.

In step 127, if the pressure Pm is less than the second pressure threshold Pth2, the process proceeds to step 130. If the pressure Pm is greater than or equal to the second pressure threshold Pth2, the process proceeds to step 150.

In the second embodiment, when the start condition including that the pressure Pm acquired by the pressure sensor 57 is smaller than the predetermined first pressure threshold Pth1 is satisfied, the start control for starting the operation of the fuel cell 20 is performed (see S115: Yes and S140 in FIG. 3). In addition,
(i) The pressure Pm acquired by the pressure sensor 57 is larger than the first pressure threshold Pth1 (see S115: No of FIG. 3), and
(ii) After the fuel gas is supplied to the adjusting unit 56 toward the fuel cell 20, the pressure Pm acquired by the pressure sensor 57 becomes smaller than the predetermined second pressure threshold Pth2 (see S122 and S127: Yes in FIG. 3),
If additional start criteria are met, including, start control is also performed (sec S140 in FIG. 3).

By performing such a process, since the length Tia of the deactivation period in which the operation of the fuel cell 20 has not been performed is long, when the pressure in the anode gas supply passage 52 on the fuel cell 20 side becomes larger than the first pressure threshold Pth1 with respect to the pressure reducing valve 55, it is possible to avoid a situation in which the starting control is not performed even though the function of the pressure reducing valve 55 is not abnormal. At this time, since the pressure Pm acquired by the pressure sensor 57 is smaller than the second pressure threshold Pth2 after the fuel gas is supplied to the adjusting unit 56 toward the fuel cell 20, a situation in which the starting control is performed can be avoided even though the function of the pressure reducing valve 55 is abnormal (see S127: Yes in FIG. 3).

In a second embodiment,
(i) The pressure Pm acquired by the pressure sensor 57 is larger than the first pressure threshold Pth1 (see S115: No of FIG. 3), and
(ii) After the fuel gas is supplied to the adjusting unit 56 toward the fuel cell 20, the pressure Pm acquired by the pressure sensor 57 is not smaller than the first pressure threshold Pth1 within a predetermined time (see S127: No of FIG. 3).
When the additional stop condition is satisfied, the start control is not performed, and the pressure-abnormality detection process is executed (see S150 in FIG. 3).

Therefore, when the pressure reducing valve 55 cannot sufficiently shut off the anode gas supplied from the anode gas tank 51, it is possible to avoid the operation of the fuel cell system 100 contrary to the instruction from the driver.

### C. Third Embodiment

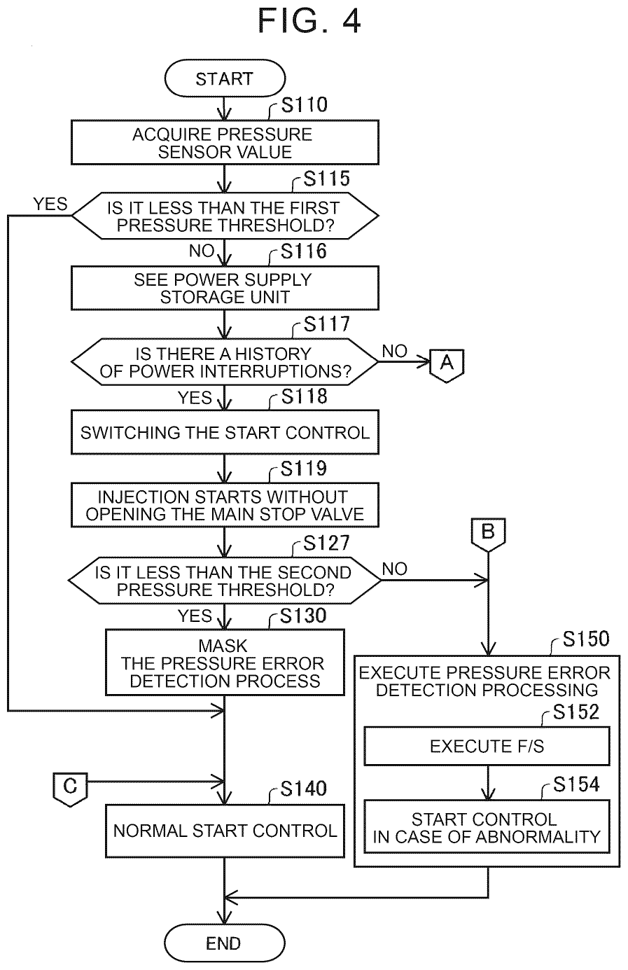

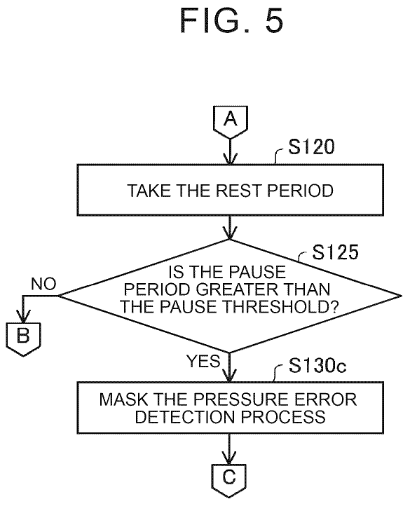

FIG. 4 and FIG. 5 are flow charts showing processes in the third embodiment executed when an instruction Is indicating that the operation of the fuel cell 20 should be started is received (see the upper part of FIG. 1). In the processing of FIGS. 4 and 5, the processing of steps 116 to 119 is executed instead of the processing of step 122 of FIG. 3. Further, the process branches from step 117, and the process of step 120,125,132 is executed. The configuration and processing of the fuel cell system of the third embodiment are the same as those of the fuel cell system of the second embodiment. In FIGS. 4 and 5, steps that perform the same processing as the steps illustrated in FIGS. 2 and 3 are denoted by the same reference numerals.

In step 116, the control unit 92 refers to the history of interruption of power supply to the operation storage unit 94 recorded in the power supply storage unit 96.

In step 117, the control unit 92 determines whether or not the interruption of the supply of power to the operation storage unit 94 is stored in the power supply storage unit 96. If the interruption of the supply of power to the operation storage unit 94 is stored in the power supply storage unit 96, the process proceeds to step 118. If the interruption of the supply of power to the operation storage unit 94 is not stored in the power supply storage unit 96, the process proceeds to step 120 (see A in FIG. 4 and the upper part of FIG. 5).

The processing of step 120,125 is the same as the processing of step 120,125 in the first embodiment. In step 125, if the length Tia of the pause period is less than or equal to the pause threshold Tthia, the process proceeds to step 150 (see B of FIG. 5 and the lower right part of FIG. 4). If the length Tia of the pause period is greater than the pause threshold Tthia, the process proceeds to step 130c. As can be distinguished from step 130 shown in FIG. 4, step 130 is shown as “step 130c” in FIG. 5. The process in step 130c is the same as step 130 in the first embodiment. After the step 130c, the process proceeds to step 140 (see C in FIG. 5 and the lower part of FIG. 4).

That is, also in the third embodiment, when the second starting condition including that the pressure Pm acquired by the pressure sensor 57 is larger than the first pressure threshold Pth1 and the length Tia of the pause period stored in the operation storage unit 94 is larger than the predetermined pause threshold Tthia is satisfied, the start control is performed (see S115: No, S117: NO in FIG. 4, S125: Yes in FIGS. 5, and S140).

In step 118, the control unit 92 switches the start control from the normal start control (see S140 in FIG. 4). Specifically, the processing in step 119 and subsequent steps is performed.

In step 119, the control unit 92 causes the adjusting unit 56 to supply the fuel gas. At this time, the main stop valve 54 and the pressure reducing valve 55 are closed. The process of step 119 is different from the process of step 122 of FIG. 3 in that the main stop valve 54 is closed.

The control unit 92 acquires the pressure in the anode gas supply passage 52 between the pressure reducing valve 55 and the adjusting unit 56 from the pressure sensor 57 when a predetermined time-threshold Tth has elapsed after the fuel gas is supplied to the adjusting unit 56 (see the right part of the middle stage in FIG. 1).

The processing of step 127 in FIG. 4 is the same as the processing of step 127 in the second embodiment.

In the anode gas supply passage 52, when the pressure reducing valve 55 is capable of sufficiently shutting off the anode gas, when the fuel gas is supplied to the adjusting unit 56, the anode gas in the anode gas supply passage 52 between the pressure reducing valve 55 and the adjusting unit 56 flows downstream. Therefore, the pressure in the anode gas supply passage 52 between the pressure reducing valve 55 and the adjusting unit 56 is greatly reduced. If so, a Yes determination is made at step 127.

On the other hand, in the anode gas supply passage 52, when the pressure reducing valve 55 cannot sufficiently shut off the anode gas, the anode gas between the pressure reducing valve 55 and the adjusting unit 56 flows downstream, while the high-pressure anode gas in the anode gas supply passage 52 between the pressure reducing valve 55 and the main stop valve 54 enters the anode gas supply passage 52 between the pressure reducing valve 55 and the adjusting unit 56 via the pressure reducing valve 55. Therefore, even if the fuel gas is supplied to the adjusting unit 56, the pressure in the anode gas supply passage 52 between the pressure reducing valve 55 and the adjusting unit 56 does not significantly decrease within the time-threshold Tth. If so, a No determination is made at step 127.

In the third embodiment, the main stop valve 54 is closed, and a drop in the pressure downstream of the pressure reducing valve 55 is confirmed (see S119 in FIG. 4). Therefore, in a case where the pressure reducing valve 55 has failed and the flow of the gas cannot be sufficiently shut off, it is possible to reduce the possibility that the downstream adjusting unit 56 is destroyed by being exposed to the high-pressure fuel gas, or the relief mechanism included in the adjusting unit 56 is opened and the fuel gas is ejected to the outside. For example, the relief mechanism may be opened as described above in a case where the valve element included in the adjusting unit 56 is configured to be pressed from the upstream side to the downstream side when the valve is closed.

In step 127 of FIG. 4, if the pressure Pm is less than the second pressure threshold Pth2, the process proceeds to step 130. If the pressure Pm is greater than or equal to the second pressure threshold Pth2, the process proceeds to step 150.

In a third embodiment,
(i) The pressure Pm acquired by the pressure sensor 57 is larger than the first pressure threshold Pth1 (see S115: No of FIG. 4),
(ii) The interruption of supplying power to the operation storage unit 94 is stored (see S117: Yes of FIG. 4), and
(iii) After the fuel gas is supplied to the adjusting unit 56 toward the fuel cell 20, the pressure Pm acquired by the pressure sensor 57 becomes smaller than the predetermined second pressure threshold Pth2 (see S119 and S127: Yes in FIG. 4),
If the third start condition is satisfied, including (S140), start control is performed.

By performing such a process, it is possible to avoid a situation in which the start control is not performed even though there is no abnormality in the function of the pressure reducing valve 55 in the following cases. That is, when the length Tia of the pause period in which the operation of the fuel cell 20 was not performed is larger than the pause threshold Tthia (refer to S125: Yes of FIG. 5), the pressure in the anode gas supply passage 52 on the fuel cell 20 side is larger than the first pressure threshold Pth1 with respect to the pressure reducing valve 55 (refer to S115: Yes of FIG. 4), and the length Tia of the pause period is not stored in the operation storage unit 94 because the supply of electric power to the operation storage unit 94 is interrupted (refer to S117: Yes of FIG. 4), it is possible to avoid a situation in which the starting control is not performed. At this time, since it is conditioned that the pressure Pm acquired by the pressure sensor 57 becomes smaller than the second pressure threshold Pth2 after the fuel gas is supplied to the adjusting unit 56 toward the fuel cell 20 (sec S127: Yes in FIG. 4), it is possible to avoid a situation in which the starting control is performed even though the function of the pressure reducing valve 55 is abnormal.

### D. Other Embodiments

### D1. Another Embodiment 1

(1) In the above-described embodiment, the adjusting unit 56 is a linear solenoid valve (see the middle portion of FIG. 1). However, the adjusting unit 56 may have another configuration such as an injector.

(2) In the first embodiment, the pressure sensor 57 acquires the pressure in the anode gas supply passage 52 between the pressure reducing valve 55 and the adjusting unit 56 (see the right part of the middle stage in FIG. 1). However, the pressure sensor 57 may acquire the pressure in the anode gas supply passage 52 between the adjusting unit 56 and the fuel cell 20 (see the right part of the middle stage in FIG. 1). The processing of steps 110, 115, 119, 127 may be performed based on measurements of the pressure sensor 58.

(3) In the first embodiment, the first starting condition is that the pressure Pm acquired by the pressure sensor 57 is smaller than a predetermined first pressure threshold Pth1 (see S115: Yes of FIG. 2). However, the first start condition may include other weighting conditions such as, for example, that the operation mode of the fuel cell system 100 is set to a predetermined mode. The same applies to the second start condition and the third start condition.

(4) The second pressure threshold Pth2 in the second embodiment and the third embodiment may be higher than the first pressure threshold Pth1, lower than the first pressure threshold Pth1, or equal to the first pressure threshold Pth1. The second pressure thresholds Pth2 can be determined according to the hardware configuration of the anode gas supply passage 52, the pressure reducing valve 55, and the adjusting unit 56, and the duration from the supply of the fuel gas to the adjusting unit 56 until the pressure sensor 57 measures the pressure. In the case where the second pressure threshold value is set to be high, the detection of the decrease in pressure is performed when a short time elapses after the fuel gas is supplied to the adjusting unit 56. When the second pressure threshold value is set lower than that, the detection of the decrease in pressure is performed when a longer time has elapsed since the fuel gas is supplied to the adjusting unit 56.

(5) The second pressure threshold Pth2 in the third embodiment is the same as the second pressure threshold Pth2 in the second embodiment. However, when a decrease in pressure is detected in a state where the main stop valve 54 is closed, the second pressure threshold Pth2 may be set lower than when a decrease in pressure is detected in a state where the main stop valve 54 is opened.

(6) In the above-described embodiment, in step 154, the control unit 92 performs start control at the time of abnormality. Specifically, the control unit 92 performs setting so that, even if an instruction Is indicating that the operation of the fuel cell 20 is to be started is input via the input unit 97, the power is turned off immediately after the power is turned on (see S150 of FIG. 2). However, in step 150, the control unit 92 may only perform a process of closing the main stop valve 54 and stopping the fuel cell system 100 for the current instruction Is indicating that the operation of the fuel cell 20 should be started without performing such a process.

(7) In the above-described embodiment, the fuel cell system 100 is mounted on a vehicle. However, the fuel cell system 100 may be mounted on another moving body such as a ship or an airplane, or may be installed in a building or the like.

### D2. Another Embodiment 2

In the third embodiment,
(i) The pressure Pm acquired by the pressure sensor 57 is larger than the first pressure threshold Pth1 (see S115: No of FIG. 4),
(ii) The interruption of supplying power to the operation storage unit 94 is stored (see S117: Yes of FIG. 4), and
(iii) After the fuel gas is supplied to the adjusting unit 56 toward the fuel cell 20, the pressure Pm acquired by the pressure sensor 57 becomes smaller than the predetermined second pressure threshold Pth2 (see S119 and S127: Yes in FIG. 4),
If the third start condition is satisfied, including (S140), start control is performed.

However, as shown in the first embodiment, not the third start condition, the pressure Pm acquired by the pressure sensor 57 is larger than the first pressure threshold Pth1, and the length Tia of the pause period stored in the operation storage unit 94 is larger than the predetermined pause threshold Tthia even when the second start condition including, is satisfied, start control may be performed (see S115: No, S125: Yes and S140 in FIG. 2).

### D3. Another Embodiment 3

After the main stop valve 54 is closed and the anode gas is supplied to the adjusting unit 56 toward the fuel cell 20, the start control is performed when the third start condition including that the pressure Pm acquired by the pressure sensor 57 is smaller than the second pressure threshold Pth2 within a predetermined time threshold Tth is satisfied (see S119, S127: Yes and S140 in FIG. 4).

However, as shown in the second embodiment, it may be determined whether or not the pressure Pm acquired by the pressure sensor 57 is smaller than the second pressure threshold Pth2 with the main stop valve 54 closed (see S122 and S127 in FIG. 3).

### D4. Other Embodiment 4

In the second embodiment and the third embodiment, the start control is performed (S140) when the start condition including that the pressure Pm acquired by the pressure sensor 57 is smaller than the predetermined second pressure threshold Pth2 (see S127: Yes and S127: Yes in FIG. 3) is satisfied after the fuel gas is supplied to the adjusting unit 56 toward the fuel cell 20.

However, instead of such a condition, as shown in the first embodiment, the start control may be performed when the start condition including that the length Tia of the pause period stored in the operation storage unit 94 is larger than the predetermined pause threshold Tthia is satisfied (see S115: No, S125: Yes and S140 in FIG. 2).

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve some or all of the above issues or to achieve some or all of the above effects. When the technical features are not described as essential in this specification, the technical features can be deleted as appropriate.

What is claimed is:

1. A fuel cell system comprising:
a fuel cell;
a fuel gas tank that holds a fuel gas;
a gas flow path that connects the fuel cell and the fuel gas tank to allow the fuel gas to flow through the gas flow path;
a pressure reducing valve provided in the gas flow path, capable of allowing the fuel gas supplied from the fuel gas tank to flow through the pressure reducing valve with a pressure of the fuel gas reduced, and capable of shutting off the fuel gas supplied from the fuel gas tank;
a pressure sensor capable of acquiring a pressure in the gas flow path on a side of the fuel cell with respect to the pressure reducing valve;
an operation storage unit that stores a length of a quiescent period of the fuel cell system; and
a control unit that controls the fuel cell system, wherein:
the control unit performs start control for starting operation of the fuel cell when an instruction to start the operation of the fuel cell is received, and when a first start condition is met, the first start condition including the pressure acquired by the pressure sensor being less than a first pressure threshold determined in advance; and
the control unit performs the start control when a second start condition is met, the second start condition including the pressure acquired by the pressure sensor being more than the first pressure threshold and the length of the quiescent period stored in the operation storage unit being more than a quiescent threshold determined in advance.

2. The fuel cell system according to claim 1, further comprising:
an adjusting unit provided in the gas flow path on a side of the fuel cell with respect to the pressure reducing valve to receive the fuel gas and supply the fuel gas to the fuel cell at a specified opening degree; and
a power supply storage unit that stores a shutoff of supply of power to the operation storage unit, wherein:
the pressure sensor acquires a pressure in the gas flow path between the pressure reducing valve and the adjusting unit; and
the control unit performs the start control when an instruction to start the operation of the fuel cell is received and when a third start condition is met, the third start condition including
(i) the pressure acquired by the pressure sensor being more than the first pressure threshold,
(ii) a shutoff of supply of power to the operation storage unit being stored, and
(iii) the pressure acquired by the pressure sensor becoming less than a second pressure threshold determined in advance after the adjusting unit is caused to supply the fuel gas toward the fuel cell.

3. The fuel cell system according to claim 2, further comprising a main stop valve provided in the gas flow path on a side of the fuel gas tank with respect to the pressure reducing valve to allow or shut off a flow of the fuel gas, wherein the pressure acquired by the pressure sensor becoming less than the second pressure threshold after the adjusting unit is caused to supply the fuel gas toward the fuel cell includes the pressure acquired by the pressure sensor becoming less than the second pressure threshold within a time threshold determined in advance after the adjusting unit is caused to supply the fuel gas toward the fuel cell with the main stop valve in a closed state.

4. A fuel cell system comprising:
a fuel cell;
a fuel gas tank that holds a fuel gas;
a gas flow path that connects the fuel cell and the fuel gas tank to allow the fuel gas to flow through the gas flow path;
a pressure reducing valve provided in the gas flow path, capable of allowing the fuel gas supplied from the fuel gas tank to flow through the pressure reducing valve with a pressure of the fuel gas reduced, and capable of shutting off the fuel gas supplied from the fuel gas tank;
an adjusting unit provided in the gas flow path on a side of the fuel cell with respect to the pressure reducing valve to receive the fuel gas and supply the fuel gas to the fuel cell at a specified opening degree;
a pressure sensor capable of acquiring a pressure in the gas flow path between the pressure reducing valve and the adjusting unit; and
a control unit that controls the fuel cell system, wherein:
the control unit performs start control for starting operation of the fuel cell when an instruction to start the operation of the fuel cell is received, and when a start condition is met, the start condition including the pressure acquired by the pressure sensor being less than a first pressure threshold determined in advance; and
the control unit performs the start control when an additional start condition is met, the additional start condition including
(i) the pressure acquired by the pressure sensor being more than the first pressure threshold, and
(ii) the pressure acquired by the pressure sensor becoming less than a second pressure threshold determined in advance after the adjusting unit is caused to supply the fuel gas toward the fuel cell.
